(19) United States
(12) Patent Application Publication
(10) Pub. No.: US 2009/0272338 A1
(43) Pub. Date: Nov. 5, 2009

(54) Wound disturbance protection device

(76) Inventors: Richard M. Cooke, JR., Lake Forest, CA (US); Diane Lee Cooke, Lake Forest, CA (US)

Correspondence Address: CURTIS L. HARRINGTON, 6300 STATE UNIVERSITY DRIVE, SUITE 250, LONG BEACH, CA, 90815, US

(21) Appl. No.: 12/386,975

(22) Filed: Apr. 24, 2009

Related U.S. Application Data
(63) Continuation-in-part of application No. 12/316,035, filed on Dec. 8, 2008.
Application No. 12/316,035 is a continuation-in-part of application No. 12/151,044, filed on May 1, 2008.

(51) Int. Cl. A61D 99/00; A01K 13/00

(52) U.S. Cl. 119/850

(57) ABSTRACT

A wound disturbance protection device can utilize a small replaceable battery of about three volts, and utilizes a circuit board containing a micro-controller, a sensible voltage output circuit, which may have a direct current or an alternating current output, and an extended tongue or other structure touch circuit having a replaceable flexible adhesive backed electrical circuit, and the circuit board may be removable from the flexible adhesive backed electrical touch circuit. A deep sleep mechanism operates to conserve battery power when the flexible electrical circuit is not connected. The applied shock is only external to the bandage and will thus be localized to the animals sense organs on touch and will avoid any possibility of current and voltage coursing through other parts of the animal's body.

This application is a continuation-in-part application of co-pending U.S. patent application Ser. No. 12/316,035 filed Dec. 8, 2008, which was a continuation-in-part of then co-pending U.S. patent application Ser. No. 12/151,044 filed May 1, 2008.

### BACKGROUND OF THE INVENTION

This invention relates to a method and technique for providing a long lasting, safe and power conserving device to inhibit wounded animals from harming their wounds and damaging their dressings.

### BACKGROUND OF THE INVENTION

Animals which have the ability to molest their healing wounds cause a lot of problems for themselves and for their owners. Where a pet owner takes the pet to a veterinarian, significant time and money is spent to place the pet in a position to maximize chances for recovery. In some cases it is desired to isolate an injured part of the pet's body from the pet's ability to bite or chew it as well as to bite or chew any dressing or other healing structure. Other healing structures may include bandages, sleeves, pins, catheters, drains and in some cases a wound area covering. Further the areas to be isolated may or may not be actual physical injury areas, but may be a rash or an infection.

Restraining structures have been employed to try and constrain the pet from damaging either the injured area or the healing structure. These can cause the pet significant discomfort. One example is the Elizabethan collar (E-collar) neck cone which can annoy the animal to the point of distraction. Other less annoying structures include electrical apparatus for prevention of wetted chewing of the affected area. For Example, U.S. Pat. No. 5,896,830 to Stampe entitled “ELECTRICAL APPARATUS FOR DISCOURAGING ANIMALS FROM INSTINCTIVELY LICKING THEIR WOUNDS” discloses a fold-over apparatus capturing a battery in the fold and uses a flat self-adhesive layer for direct pressure sensitive sticking to an area near the wound. The device of Stampe has several limitations. First, the device has a very abbreviated area and yet has to depend only upon being stuck only flatly near the wound. It has a powerful adhesive and is prone to being nudged off without an overwhelming power of such adhesive, given its relatively small adhesion footprint. Further, the electrical current is based upon a simple short circuit. This includes two severe limitations. First, the voltage and current is based upon the voltage and internal resistance of the battery. This means that a single lick can produce a closed circuit which can deplete the battery in a short period of time. Other conductive short circuits from mud puddles or salt water can also deplete the circuit power. In effect, this device might, depending upon the viscosity and conductivity of the animal's saliva, become a one lick device. If the device is not believed to be effective with one battery, a user can stack two or three additional batteries in series to increase the voltage and current. The “folding action” of the “energization switch” enables more batteries to be added to the stack. Second, there is no way to control the conduction once it begins. At best this can deplete the battery source in a few minutes. At its worse it can cause local heating in either the conductive traces or battery or both and burn the animal. An owner who finds that the device is not working can thus try to increase the voltage but only by increasing the danger by adding more batteries to increase voltage and also increase the burn danger.

Similarly, U.S. Pat. No. 4,153,009 to William Boyle entitled “ELECTRIC SHOCK TRAINING DEVICE FOR ANIMALS” uses a pair of 9 volt batteries connected in series to supply, with a three conductor bus bar where the center bus bar is negative and two adjacent bus bars are positive. The assembly is attached using the housing and bus bar support and has a method for attaching the end of the bus bar support back to the housing. The apparatus overlies what might be characterized as a conventional dressing. The Boyle device is not much different from Stampe in that it simply attempts to provide a much higher voltage by using a pair of nine volt batteries. The short circuit danger in the Boyle device is still a significant danger.

Other devices include U.S. Pat. No. 7,219,627 to Egloff entitled “ELECTRICAL BANDAGE PROTECTOR” and in which a battery of from 9 to 12 volts is used, but with a fuse to prevent over heating upon short circuit. The Egloff device and the Egloff reference teaching both at least contemplate the danger of using a battery power supply, but the use of a fuse which must be continually replaced does neither the owner nor the healing animal any favors.

In another device, U.S. Pat. No. 6,561,136 to Charles Kuntz entitled “ELECTRONIC DEVICE FOR VETERINARY PATIENTS” teaches the construction of an insulated dressing with a conductive cover. A shock device is connected between the conductive outer layer and the animal's body such that any chewing on the conductive exterior of the bandage completes a circuit through the inside of the animal's body to give a “head conductive” shock sensation. In one figure it is clear that one electrode is connected away from the bandage and near the animal's chest to direct current through the animal's chest as a manner of completing the circuit. In an injured animal, causing current to course through parts of the body could be deleterious given the potential for a weakened animal or the opportunity for internal current flow to disrupt what may already be weakened internal organs. The defibrillative orientation of the electrodes taught by Kuntz should be avoided. Further, the animal with the Kuntz device will receive a shock if his dressing becomes wet and if it touches any other part of his body. This can result in an animal who is punished with electrical body shock based upon how it sits or lies, even if the wound area is not chewed or molested.

In all of the foregoing examples, battery depletion, over current danger with heating or burning is a potential problem, among others. But a further problem involves the damage to the injured animal due to a discouragement device which fails. Failure of such a device can actually encourage an animal to further destroy the dressing and further inflict damage to the wound or inflamed area. Further, the animal's owner cannot tell whether the device is functioning or not merely upon inspection. The user must either obtain a voltmeter to see if the device is still working, or lick the electrodes as a test. From the injured animal's perspective the device “teaches” the animal to avoid the wounded or inflamed area. When the device is tested by the animal and it does not work, it invites the animal to continue to invade the area originally sought to be protected. Further, where a battery is used which is depleted of voltage and current over time, the animal is taught that each molestation of the forbidden area becomes easier. In effect, the animal is taught that persistence will be rewarded with diminished resistance.

What is needed is a body protector for an animal which (1) eliminates the possibility of a depleting short circuit, (2) which indicates that it is functioning, (3) which has the ability to deliver a more noticeable yet safer training shock to the animal, and (4) which has the ability to dissuade the animal by delivering shocks of either increased or random intensity over time to teach the animal away from the perception that increased persistence will result in a diminished response for the area to be protected.

### SUMMARY OF THE INVENTION

A pet bandage protection system can utilize a small replaceable battery of about three volts, and utilizes a circuit board or flex circuit, containing a micro-controller, a DC-DC converter and an extended tongue touch circuit having a replaceable flexible adhesive backed electrical circuit. The flexible circuit is preferably attached in a spiral fashion to present an alternating set of conductors and may preferably be used atop a bandage. The applied shock is only external to the bandage and will thus be localized to the animals sense organs on touch and will avoid any possibility of current and voltage coursing through other parts of the animal's body.

When the micro-controller detects the pet's tongue or mouth touching the flexible circuit a change in resistance is detected through the flexible circuit, and the microprocessor directs a mild, time duration limited pulsed shock of (using the components described) up to twenty eight to thirty volts direct current or less or more through the flexible circuit. Other designs are possible which have different voltage and current ratings. The use of a direct current-direct current converter enables a battery nominally rated at three volts to output twenty-eight volts such that the output is between nine and ten times the battery voltage. Battery consumption is conserved as the micro-controller spends the majority of the time in a “sleep” mode. At regular intervals the micro-controller wakes up measures the battery voltage and flashes the green LED if the battery voltage is in the acceptable range. This flashing assures the animal care giver that the device is working and has sufficient power. If the battery voltage is low the micro-controller will flash a red LED to indicate the need for a battery change. Thus, the animal care giver will always quickly be able to ascertain the operating status of the system visually. The battery is replaceable so the invention herein will allow the end user to keep the product until the next time when any other animal requires a bandage. In an institutional setting, a veterinarian need only purchase a dozen or so of the devices, which are expected to almost never wear out.

In one embodiment, the circuit board may be attached to the flexible circuit by two thumb crews allowing the end user to readily replace the flexible circuit and save the electronics package for a later use. A flexible circuit utilizable in conjunction with the electronics package will be available separately and depending upon the surface to which it is attached it may not likely be re-usable. In an institutional setting and when used with several animals the provision of a new flexible circuit for each animal will very likely be required for sanitary purposes.

The re-usability of the electronics package will enable a lower cost of the whole system over time, to allow the end user to minimize long term cost and to be used to protect injured animals well beyond the lifetime of any given animal.

The micro-controller programming will allow a single three volt lithium coin cell to operate the protection system for up to a year. The flexible protection circuit can be made in various sizes and configurations. A twelve to forty eight inch long and three quarters of an inch wide flexible circuit may be and preferably is wrapped in a spiral to form a somewhat cylindrical structure to protect an animal's extremity. A rectangular shaped flexible circuit can be used to protect an animal's abdomen.

The electronics package is controlled by a micro-controller that is in the “low-power” mode until the resistance between the positive and negative traces decreases to a threshold setting. The low resistance condition can “awaken” the micro-controller from its low power mode and cause the DC-DC converter to be enabled. The micro-controller then energizes the flexible circuit such that the animal will then receive a mild shock. After receiving the mild shock it is expected that the animal will remove his tongue or mouth from the bandage protector. If this occurs, and then in the absence of the tongue or mouth the resistance between the traces of the flexible circuit, the resistance rapidly increases above the threshold point, and this is also detected by a tongue touch circuit such that the micro-controller enters the low power mode. This asynchronous behavior is one of the keys to long battery life, in contrast with conventional systems which must use multiple coin cell batteries (in series) and which will last only five to seven days. The design of the inventive device will allow the end user to protect a bandage for up to 1 year before the battery needs to be replaced.

Even more importantly, circumstances which would cause a false trigger will not deplete the battery nor create a burn hazard. For example, if the animal steps into a salt water puddle, the micro-controller will deliver a pulse and then may wait for a change. Even where the micro-controller does not detect a change after a number of pulses it may wait longer and longer between pulses and then go into sleep mode for some specified time before re-awakening and testing for a resistance threshold. The same conditions might also be created where the animal contacted metal, such as a grate or where the animal rests against a conductive structure. The use of measured, time limited pulses not only protects the animal, but also preserves the battery and prevents the animal care giver from having to continually replace batteries, as is the case for conventional devices.

The structure and operating system of the animal protector apparatus is constructed for long life and battery conservancy, including a low energy or “sleep” cycle as the predominant duty cycle until the circuit detects a low resistance condition which indicates a disturbance by the presence of an animal tongue or mouth. The firmware further maximizes the battery life by adjusting the time between shock episodes such that if a low resistance condition occurs for more than a set time, the system inhibits the shock until an ever increasing delay has expired. This will protect the battery from draining due to the pet getting the bandage and flexible circuit wet.

The generation of a dissuasion voltage of about twenty-eight volts is believed to be sufficient to train and deter the animal from licking or destroying its bandage, but without being unduly disruptive or upsetting to the animal. The modular construction of the animal protector apparatus enables the flexible circuit portion to be disposable while the circuit board portion can be used again and again. Further, the flexible circuit portion may be available in a long length and can be cut to be shorter as needed.

### BRIEF DESCRIPTION OF THE DRAWINGS

The invention, its configuration, construction, and operation will be best further described in the following detailed description, taken in conjunction with the accompanying drawings in which:

FIG. 1 is an exploded view showing a circuit board, flexible circuit and thumb connectors which attach the flexible circuit electrically and mechanically to the circuit board;

FIG. 2 is a cross sectional view of the flexible circuit taken along line 2-2 of FIG. 1, and which preferably illustrates a pair of conductors on the upper side and also having a lower layer of contact adhesive which may preferably be covered with a removable release strip;

FIG. 3 is an end view taken along line 3-3 of FIG. 1 and showing a battery mechanically held and electrically connected to the components on the circuit board, and shown opposite the assembled threaded thumb connectors which are shown attached to their respective terminals;

FIG. 4 illustrates a block diagram of one embodiment of the wound disturbance protection device;

FIG. 5 illustrates a flowchart through which the normal operating steps of power-up and ready status are indicated;

FIG. 6 illustrates detailing the steps taken upon detection of any conductive or wetted disturbance to the conductors of the flexible circuit seen in FIG. 1;

FIG. 7 illustrates one realization of a circuit which can be utilized with the animal protector apparatus seen in the foregoing figures;

FIG. 8 illustrates one variation of the one realization of a circuit which can be utilized with the animal protector apparatus as was seen in FIG. 7 with the direct current generating component replaced by an alternating current device;

FIG. 9 illustrates a leg of a dog fitted with the animal protector apparatus of the invention and seen as a spiral wrap over a bandage;

FIG. 10 illustrates a leg of a dog fitted with the animal protector apparatus of the invention and illustrated with anchoring bandages fitted adjacent the ends of the spiral'

FIG. 11 illustrates an elevation view of an alternative embodiment illustrates a non-spiral laterally widened bandage protector on a leg of an animal;

FIG. 12 is an expanded view of the bandage protector seen in a flattened and unrolled view to better illustrate the dimensions thereof;

FIG. 13 illustrates a slightly different non-spiral laterally widened bandage protector which includes a slightly different main expanse of flexible plastic material;

FIG. 14 illustrates a view looking into the side end of the laterally widened bandage protector to give a good illustration of the depth of the configuration seen with respect to FIG. 13;

FIG. 15 illustrates a configuration similar to that seen in FIGS. 13 and 14 as a spay patch configuration shown in conjunction with an outline of an animal which was just recently spayed;

FIG. 16 illustrates an alternative configuration for a spay patch which has a raised dome which would be positioned over an incision area;

FIG. 17 is a side view looking into the side of the wound protector along line 17-17 of FIG. 16 and illustrates the extent of the domed structure;

FIG. 18 is an end view looking into the wound protector along line 18-18 of FIG. 17 and illustrates that the end of the domed structure may be open;

FIG. 19 illustrates an alternative configuration for a spay patch is shown having a multi-piece structure replacing the elongate domed structure seen in FIG. 18;

FIG. 20 illustrates a further alternative configuration for a spay patch shown having a flap which can be used with or without a dome-type structures;

FIG. 21 illustrates a protector which includes a relatively more dense set of alternating conductors

FIG. 22 illustrates an exploded view of an area limiting layer placed over a expanse of material to help protect traces from shorting out if an animal leans against a conductive cage;

FIG. 23 illustrates a slightly different version of a protector than is seen in FIG. 22 and in which the flexible connector extends off of the expanse of material to one side; and

FIG. 24 illustrates an alternative process flow software which conserves power by preventing further shocks when a tongue is detected.

### DETAILED DESCRIPTION OF THE PREFERRED EMBODIMENTS

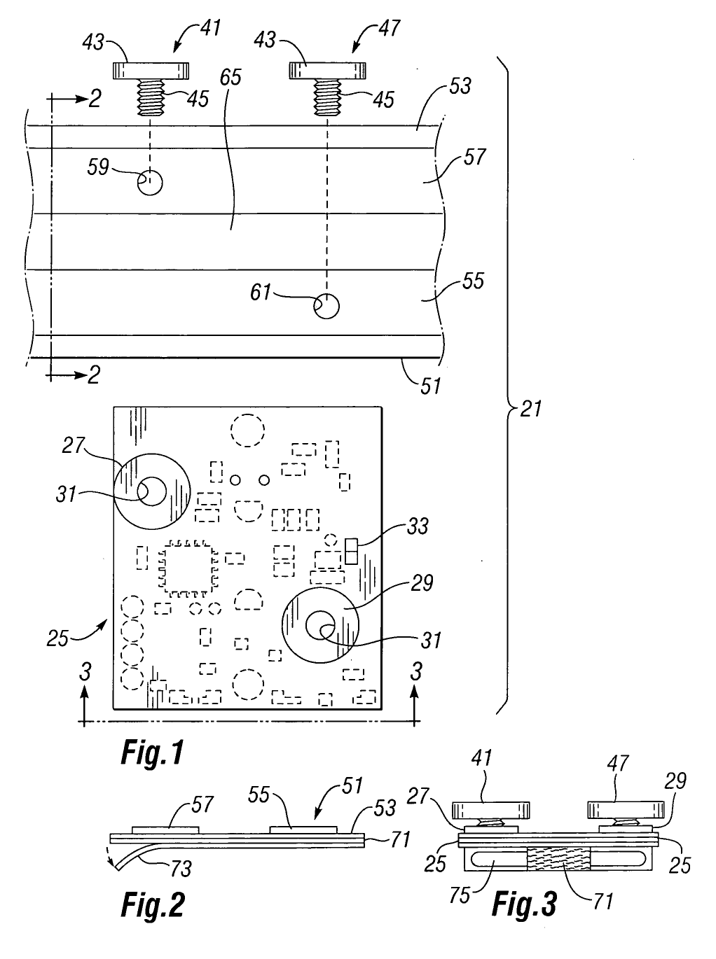

Referring to FIG. 1, an exploded view of the main parts of an animal protector apparatus 21 is illustrated. A circuit board 25 is seen as having a pair of terminals, including a first terminal 27 and a second terminal 29 each having an internally threaded bore 31. The circuit board 25 need not be rigid and can be a flex circuit with many different types of connectors as are necessary to accept power and to input and output signals. The circuit board may also have an indicator light, such as an LED 33. The other physical components on the circuit board 25 will not be identified although components will be shown in a schematic. The circuit board shown measures one inch by thirteen sixteenths of an inch. As a result of this small size, the circuit board 25 with battery attached to the rear face (not shown in FIG. 1) weighs only three tenths of an ounce.

A first threaded thumb connector 41 includes a knob 43 and a conductive threaded shaft 45. A second threaded thumb connector 47 includes a knob 43 and conductive threaded shaft 45. The threaded shafts 45 are sized to fit within the internally threaded bores 31 of the first and second terminals 27 and 29.

Between the first and second threaded thumb connectors 41 and 47 and the circuit board 25 is seen a flexible circuit 51 of indeterminate length. The left and right sides are shown with broken lines in order to illustrate that both sides of the flexible circuit 51 may extend in either direction. In one embodiment, it may be that one side may extend for several inches to a foot to enable support to be had of the circuit board 25 from either side of the flexible circuit 51. In other cases a further connection device may extend to one side. Where flexible circuit 51 is provided with several feet to either side of the section seen in FIG. 1, the user can cut and trim it as needed. Some of this need may be the method of wrapping either the area or the bandage in a manner which best fits the need of application. The user is thus free to even center the circuit board 25 where application of the flexible circuit 51 warrants it.

The flexible circuit 51 has a main expanse of non-conductive material 53 which may preferably be a flexible plastic, upon which are laid down a pair of conductors seen as conductor 55 and conductor 57. Conductor 55 has an aperture 59 while conductor 57 has aperture 61. The vertical and horizontal separation of the apertures 59 and 61 correspond to the vertical and horizontal separation of the internally threaded bores 31 of the first terminal 27 and second terminal 29 to enable the thumb connectors 41 and 47 to secure the flexible circuit 51 to the first terminal 27 and second terminal 29. This action complete both an electrical connection and a mechanical connection, especially useful where the flexible circuit 51 is used to support the circuit board 25.

It is preferable for an area 65 between the conductors 55 and 57 to be made of transparent material so that the LED 33 can be seen to flash through the flexible circuit 51. This eliminates the need to create a special configuration to insure that the LED 33 is viewable. Further, it is preferable to orient the exterior surfaces of the conductors 55 and 57 away from the circuit board 25 to insure that none of the components are inadvertently contacted. Further, the side of the flexible circuit 51 facing the circuit board 25 will preferably have a thin layer of adhesive so that the flexible circuit 51 can assume a position inside a wrapped configuration against an extremity of an animal. It is especially when used over an underlying bandage that the LED 33 can be seen flashing through the area 65 of transparent material 65.

Referring to FIG. 2, a view taken along line 2-2 of FIG. 1 illustrates a cross sectional view of the flexible circuit of FIG. 1 and illustrating the conductors 55 and 57 atop the main expanse of non-conductive material 53. A layer of adhesive 71 is seen as being covered on the underside by a release sheet 73, one corner of which is partially peeled back. With this configuration, a new flexible circuit 51 need only be connected to the circuit board 25 using the thumb connectors 41 and 47 to energize the conductors 55 and 57, then remove the release sheet 73 to expose the layer of adhesive 71, and then apply the animal protector apparatus 21 over the area to be protected by contact of the area to be protected by contact with the adhesive 71 to either the animal's skin or to the animal's bandage, wrap or other area preparation. In this position, the LED 31 will be visible through the area of transparent material 65.

FIG. 3 is a view taken along line 3-3 of FIG. 1 and illustrates a view illustrating both the top and bottom sides of the circuit board 25. The threaded thumb connectors 41 and 47 can be seen attached to the first and second terminals 27 and 29. A lower battery contact and support 71 is shown supporting a battery 75 in a very stable support configuration. Battery 75 is well supported and can be removed only by deliberate action of the user.

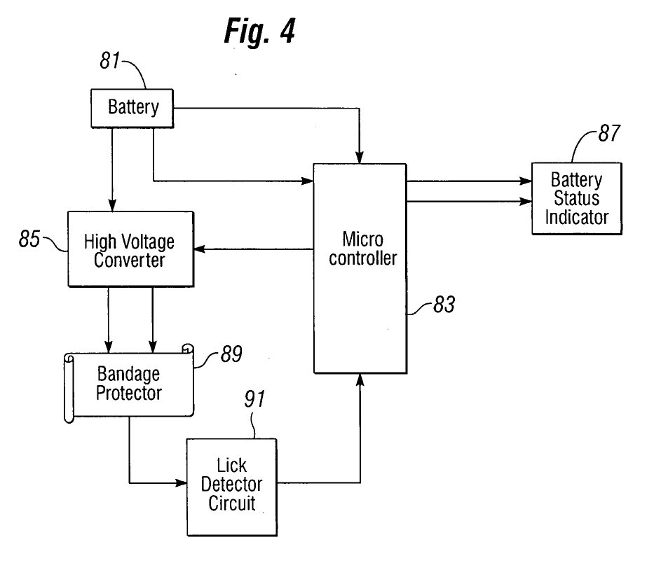

Referring to FIG. 4 a simplified block diagram of one configuration of the animal protector apparatus 21 is illustrated. As by FIG. 1, all of the components will ideally be supported on the circuit board 25. A battery 81 supplies power to a micro-controller 83 and to a High Voltage Converter 85. High Voltage Converter 85 may preferably be a direct current voltage several times the battery voltage, or it may be an alternating current alternating voltage source, also preferably several times the battery supply voltage. The battery power may also be supplied separately to the micro-controller 83 for purposes of voltage monitoring. A battery status indicator 87 may preferably be a multi-color LED such as the LED 33 seen in FIG. 1.

The High Voltage Converter 85 may be connected to the bandage protector 89, which is expected to be the flexible circuit 51 seen in FIG. 1. It should be noted that other types of bandage protector 89 can be configured to work with the circuit board 25 or as part of the animal protector apparatus 21, and thus the bandage protector 89 is a more generalized structure. A lick detector circuit 91 is shown as connected to the bandage protector 89 and to the micro-controller 83. This circuit may operate to detect animal tongue contact with the flexible circuit 51 through several methods, including the detection of reduced resistance between the terminals 27 and 29, and between the conductors 55 and 57 such that current flows, a resulting reduction in the threshold voltage between terminals 27 and 29 occurs. Further, the lick detector circuit 91 connection to the micro-controller 83 may be isolated at a time when the micro-controller 83 triggers a shock enable signal from the micro-controller 83. This may insure that any delicate measurement circuitry within the micro-controller 83 will have a reduced chance of damage when the DC-DC boost voltage converter is triggered.

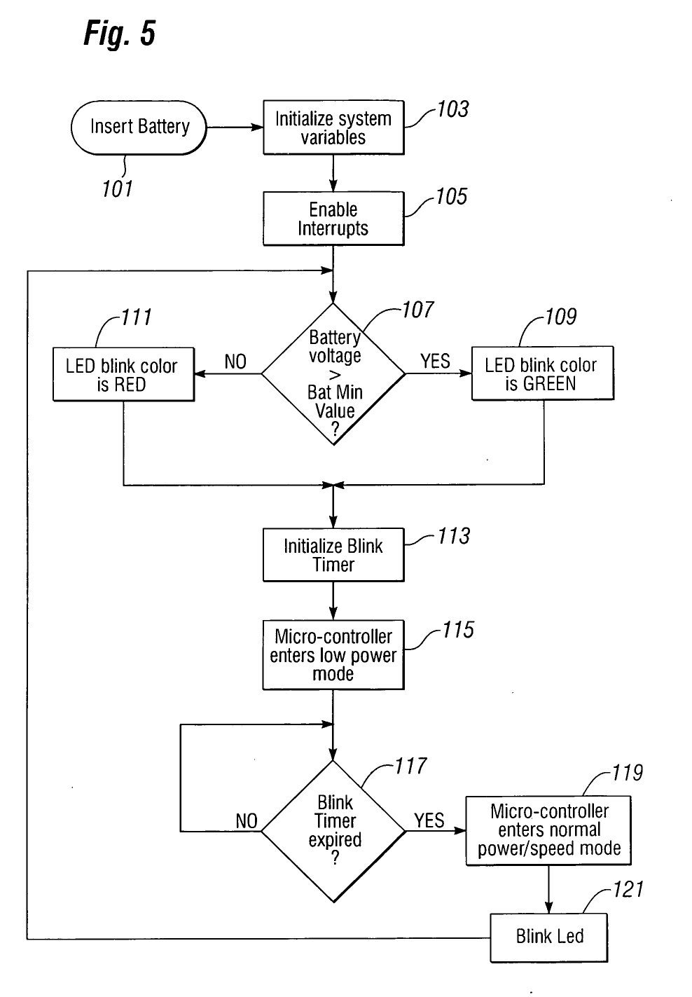

Referring to FIG. 5, a logic flowchart showing but one possible approach in programming of the micro-controller 83 is illustrated. It is understood that the interrupt based approach is for simplicity in illustrating the operation of the circuitry. As a starting point an “insert battery” starting oval 101 is utilized as the circuit board 25 will preferably have no “on/off” switch, and simple insertion of a battery 75 will start operations and logic flow. In order to save weight and expense, and due to the one year expected battery life under normal use conditions, battery insertion marks the start of operations, assuming it has sufficient voltage to operate the micro-controller 83. Upon startup, the logic flows to an “initialize system variables” block 103 at which time the programmed parameters are made available to the micro-controller 83 operating system.

The logic next flows to an “enable interrupts” block 105 which, in an interrupt based system, enables the interrupt based operation for the logic flows and actions described for 5 this and other flow charts at any point on the flowchart of FIG. 5 downstream of the “enable interrupts” block 105. The logic then flows to a “battery voltage>BAT_{MIN} value” decision diamond 107, where BAT_{MIN} may vary depending upon the characteristics and operability of a given circuit at its lower voltage limit. A “yes” result leads to a “LED blink color is GREEN” block 109. A “no” result leads to a “LED blink color is RED” block 111.

The logic flow from either of the “LED blink color is GREEN” block 109 or “LED blink color is RED” block 111 leads to an “initialize blink timer” block 113 which sets the base timing periodicity and cycle for operation of the animal protector apparatus 21. The logic next flows to a “micro-controller enters low power mode” block 115 which lowers the power until it is time to go back to “battery voltage>BAT_{MIN} value” decision diamond 107, as will be shown.

The logic next flows to a “blink timer expired” decision diamond 117. A “no” result leads back to the “blink timer expired” decision diamond 117. This loop occurs while the micro-controller is in low power mode. The “initialize blink timer” block 113 may assign a time of 3-5 seconds during which the loop established by “blink timer expired” decision diamond 117, but the overall duty cycle may be different. A “yes” result at the “blink timer expired” decision diamond 117 leads to a “micro-controller enters normal power/speed mode” block 119. The normal power/speed mode” block 119 enables the tasks of powering the LED 33 of FIG. 1, as well as battery voltage measurement. After the logic enters the “micro-controller enters normal power/speed mode” block 119 the normal power is back on, as the logic flows through a “blink LED” block and then back to the “battery voltage>BAT_{MIN} value” decision diamond 107 and repeats the flow of logic previously described. The micro-controller remains in normal power until it again encounters micro-controller enters low power mode” block 115. This program flow guarantees that the micro-controller spends the majority of the time in low power mode.

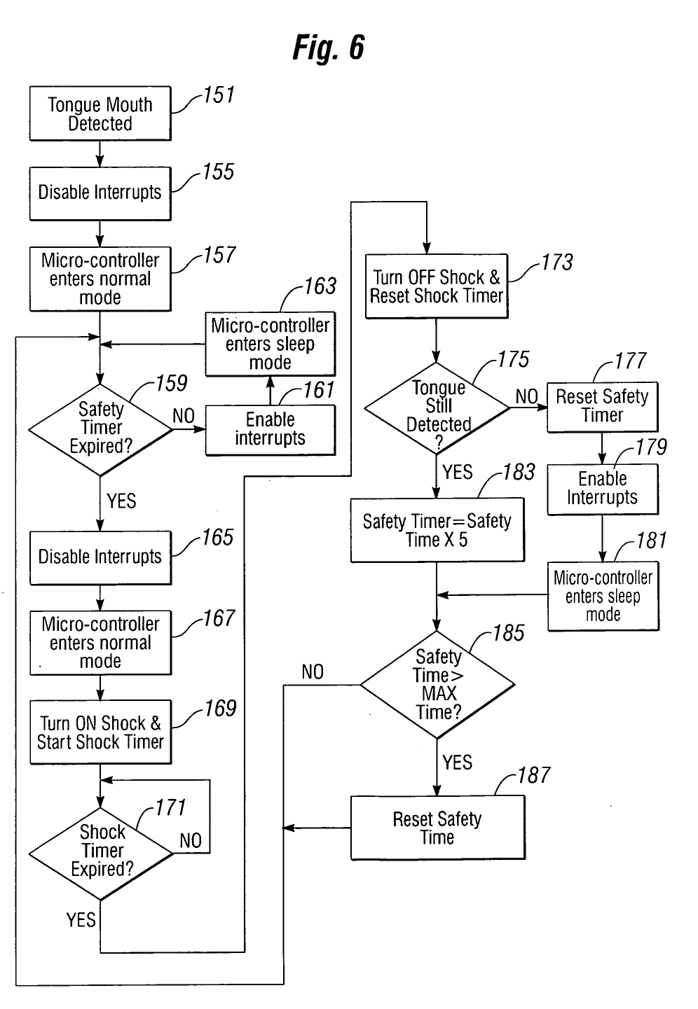

Referring to FIG. 6, one possible view of an interrupt routine is shown. The logic flow into the interrupt routine of FIG. 6 can occur from any point in the normal cyclic functioning seen in the block diagram of FIG. 5, below the “enable interrupts” block 105. An interrupt is triggered by the detection of disturbances in the first and second terminals 27 and 29, as well as their attached conductors 55 and 57, such as might occur by licking, moist touching or biting, is shown. The logic flow arrives at the subroutine of FIG. 6 at any time from any location in the logic flow seen in FIG. 5. The interrupt of this flow of logic may include the detection of the disturbance by lick or moist touch as the master interrupt which preempts all of the other interrupts. A “tongue or mouth detected” block 151 occurs by any of the methods discussed between the first and second terminals 27 and 29 as well as their attached conductors 55 and 57. If detection is had, the logic flows to an “disable interrupts” block 155 which acts as the master interrupt and prevents any further action or logic flow seen in FIG. 5, or any other interrupts other than those seen in FIG. 6.

The logic then flows to a “micro-controller enters normal mode” block 157 to take account of the possibility that the interrupt which triggered the arrival of the logic flow seen in FIG. 6 might have occurred while the micro-controller was in low power mode, with block 157 simply insuring that normal power mode is achieved before proceeding further.

The logic then flows to a “safety timer expired?” decision diamond 159. The safety timer is a separate category of time during which no further progress will be allowed in the interrupt logic flow of FIG. 6 due to the possible occurrence of a short or some other condition where the first and second terminals 27 and 29 remain shorted. The result of this condition, as will be seen, is that the time in this timer is multiplied times five for every passage through the interrupt sequence of FIG. 6 so that any shock occurs by half as often during a constant shorted state. For the “has safety timer expired?” decision diamond 159, a “no” result leads to an “enable interrupts” block 161 and then to a “micro-controller enters sleep mode” block 163. The logic then flows back to the “has safety timer expired?” decision diamond 159. Even in sleep mode, the micro-controller 83 can continue to check to see if the safety timer is expired.

A “yes” result at the “has safety timer expired?” decision diamond 159 then permits the logic to flow to a “disable interrupts” block 165 where this shock interrupt sequence will be continued without any interrupts external to this shock interrupt sequence. The logic then flows to a “micro-controller enters normal mode” block 167 where the micro-controller 83 is fully on. The logic then flows to a “turn on shock & start shock timer” block 169. These two actions occur simultaneously where the shock is turned on and the shock timer which measures the time since the shock was turned on, are initiated. In turning on the shock, the micro-controller 83 instructs the “DC-DC Boost Voltage Converter” block 85 to turn on in order to deliver a shock. The DC-DC converter enable terminal (to be shown) receives an enablement signal and turns on less than about 50 microseconds later. Second, block 169 starts the shock timer, which may be a count-down timer, which was previously stated to have a time duration of about 1 second. The shock timer may be initially set to one second and determines the length of time that a sensible shock potential will be applied between the first and second terminals 27 and 29 as well as their attached conductors 55 and 57. The shock potential can be at any level and may be of a single wave form or a series of shorter waveforms. It has been found that one voltage value which works well as a generally constant “on” applied voltage is from about twenty five to about thirty five volts, but a user may want higher or lower voltages when dealing with different animals of different size, temperament, and different resistance lowering characteristics.

The logic flow then proceeds to a “shock timer expired?” decision diamond 171. A “no” result causes the logic to flow back to the a “shock timer expired?” decision diamond 171 which entrains the logic flow until the shock timer expires. Where the shock timer is set to one second, the entrainment or holdup will continue in this loop for about one second. Only a “yes” result at the a “shock timer expired?” decision diamond 171 allows the logic to flow to a “turn off shock & reset shock timer” block 173. This ends the actual shock and timing step and allows the logic to continue on.

The logic then flows to a “tongue still detected” decision diamond 175 at which time the detection of the same type of voltage lowering/shorting event between the conductors 55 and 57 is tested. This condition may be due to an aggressive animal continuing to lick and chew at the wound area, or it could result from a short circuit where the conductors 55 and 57 are pressed against a third body conductor. Since the animal protector apparatus 21 may not be able to distinguish whether the animal is being aggressive or whether there is a short present, any low resistance between conductors 55 and 57 will be considered to be a short and a safety timer will be used to increase the permissible period between shocks under that assumption. It is thus assumed that an animal will quickly draw away from a twenty five to thirty five volt shock and that, absent the need for a safety timer that subsequent shocks will be due to a fresh molestation of the wound area. The way that the animal protector apparatus 21 reacts to continued shorting is to perform a calculation where greater and greater amounts of time are added between shocks. This increased time will conserve power by either increasing the period between shocks to either enable the animal to move away from a conductor or to allow the animal protector apparatus 21 to dry should it become wet with a conductive liquid.

As can be seen, if no further conductor is detected, as would be the case where the animal is dissuaded from molesting the area to be protected, the animal protector apparatus 21 is returned to a normal service. In its return to normal service, a “no” result at “tongue still detected” decision diamond 175 leads to a “reset safety timer” block 177. Here, any past safety times due to continued shorting, will be reduced to the standard time, which may be set at one second. The logic then flows to an “enable interrupts” block 179, where other interrupts, including a return to this interrupt routine is enabled. The logic then flows to a “micro-controller enters sleep mode” block 181. This puts the micro-controller 83 in its low power mode. Note from the interrupt driven logic that the re-entry to the flowchart of FIG. 5 is not required to re-enter at any given point or it can re-enter at the point from which the logic flow of FIG. 5 was interrupted.

In the event that the conductors 55 and 57 are still shorted, a safety timer routine starts at a “yes” result at the a “tongue still detected” decision diamond 175 which leads to a “safety time=safety time×5” block 183. The starting safety time might be as little as one second and was encountered at “safety timer expired?” decision diamond 159. The first time through the logic flow of FIG. 6, if the safety time was one second, the “yes” result at a “tongue still detected” decision diamond 175 causes that safety time to be multiplied by five, for example. The safety time would then be set to five times the current value, for example, five seconds. The logic then flows to a “safety time>max time?” decision diamond 185 where a large number is compared with the current safety time to cause it to re-set if it exceeds some large value. A “yes” result leads to a “reset safety time” block 187 where the safety time is re-set to its programmed minimum, which may be about one second. A “no” result, as well as the logic flow from the “reset safety time” block 187 leads directly back to re-entry of the logic flow back into the “safety timer expired?” decision diamond 159.

As by example, if the conductors 55 and 57 become shorted, as when an animal runs through a salt puddle, or perhaps rests on a conductive object, a device which continually sends out a shock would deplete the battery. But generally, animal protector apparatus 21 can't distinguish between the conditions which create the short in the conductors 55 and 57. The method for handling a continued shorting of the conductors 55 and 57 is as follows. When a short condition occurs, the first pass through the interrupt diagram of FIG. 6 will have a safety time equal to the minimum, and the “safety timer expired?” decision diamond 159 will cause further progress through the interrupt sequence of FIG. 6 to be momentarily entrained for the duration of the safety time, which we will assume to be one second. After the logic goes through a shock sequence from block 165 through block 175, if a short is detected or if the animal is aggressive in attacking the protected area, the “safety time=safety time×5” block 185 will multiply this one second time by five, and thus the safety time will be five seconds. The logic flow in the interrupt sequence of FIG. 6 will return to the “safety timer expired?” decision diamond 159 but will now cause further progress through the interrupt sequence of FIG. 6 to be momentarily entrained for the duration of the safety time, now five seconds.

Another passage through the interrupt sequence of FIG. 6, including the shock sequence from block 165 through block 175 will be had and if a short continues to be detected the “safety time=safety time×5” block 185 will multiply this five second time by five, and thus the safety time will be twenty five seconds. The logic flow in the interrupt sequence of FIG. 6 will return to the “safety timer expired?” decision diamond 159 but will now cause further progress through the interrupt sequence of FIG. 6 to be momentarily entrained for the duration of the safety time, now twenty five seconds.

The result of this example is that the time spacing between shocks under conditions where a short is detected will continue in an increasing sequence of five, twenty five, one hundred twenty five, six hundred, three thousand, etc. seconds. If this sequence is continued, it can be seen that the animal protector apparatus 21 would otherwise continue its spacing and would have a period between shocks on the order of days, weeks and months, only limited by the micro-controller's ability to count time. This ability to add an ever increasing time between shock sequence is limited by the “safety time>max time?” decision diamond 185, which simply specifies a maximum time which, when reached, causes the animal protector apparatus 21 and the process flows of FIG. 6 to simply start over and go through its sequence of five, twenty five, one hundred twenty five, six hundred, three thousand, etc. seconds between shocks. Again, any time that a short is not detected, at “tongue still detected” decision diamond 175, the control is returned to the main process flow diagram of FIG. 5.

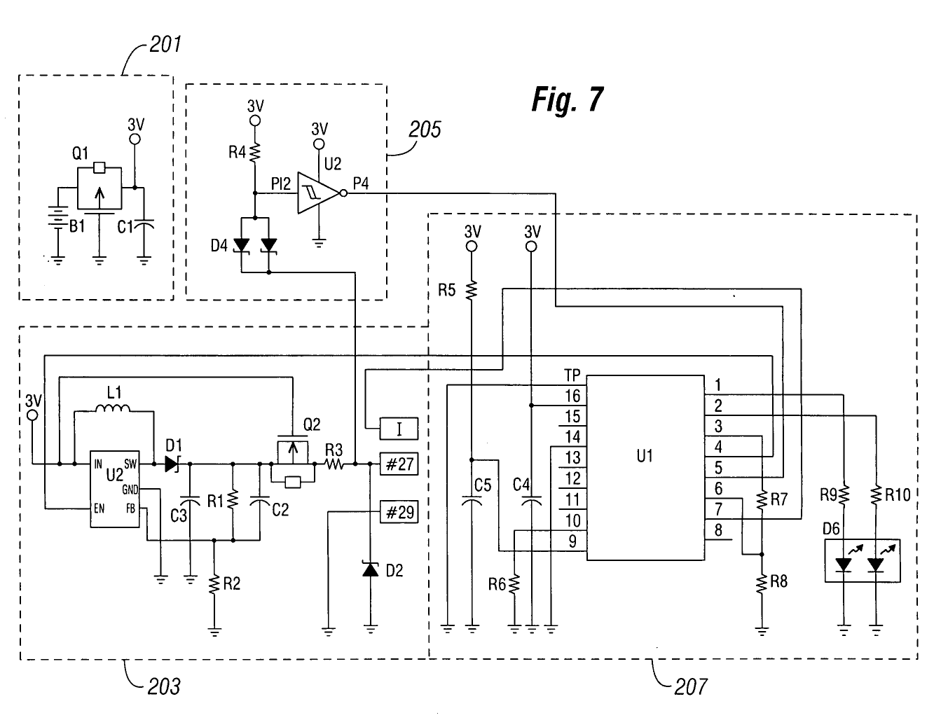

Referring to FIG. 7, one realization of a circuit to be mounted on the circuit board 25 is shown. The circuit has four main sections, including a battery input and protection section 201, a DC-DC converter section 203, a potential detection section 205, and a micro-controller section 207. The battery input section 201 includes a battery B1 is connected through a MOSFET transistor Q2 to provide reverse battery polarity protection and a lower forward voltage drop than a discrete diode to help the battery B1 last longer. The three volt potential at the output of the transistor Q2 is made available to other components in the circuit with connections seen at the circle structure adjacent the designation “3V”. This supply voltage is also connected to ground through a capacitor C1 (4.7 μf).

In the a DC-DC converter section 203, the DC-DC converter U2 may be of the type commercially available from Fairchild company, part No. FAN5333BSX. The DC-DC converter U2 has five connections including an input IN, switch SW, ground GND, enable EN and feedback FB. The voltage supply, seen as a 3V circle connection is made available to the input IN. Contacts IN and SW are connected by an inductor L1 (which may range from 4.7 to 10.0 μH depending upon voltage & other characteristics desired). DC-DC converter U2 output is connected through zener diode D1 to MOSFET Q1, and to ground through a parallel combination of R1 (2.2M) and C2 (22 pF) in series with resistor R2 (100 k). The other side of MOSFET Q2 is connected through R3 to one of the conductor 55 or conductor 57, and to ground through a zener diode D2. The diode D2 protects the output line from electrostatic discharge (ESD) damage. The other of the conductor 55 or conductor 57 is connected to ground.

The potential detection section 205 includes a Schmitt trigger inverter U3 having an input connected though a pair of zener diodes D4 to the output of the resistor R3. The input of inverter U3 is normally high, being pulled up to about three volts across R4 high, thus causing its output to be normally low. When an animal's tongue or mouth is applied across the first and second terminals 27 and 29 and the flexible circuit's conductors 55 and 57, U3's input voltage will be brought below its threshold to flip the output voltage of U3 to high and transmit this result to an input of U1 in the a micro-controller section 207. The lower voltage rail of inverter U3 is connected to ground. The inverted output of inverter U3 is made available to the a micro-controller section 207.

The micro-controller section 207 includes a micro-controller U1 having connections TP and connection 14 connected to ground, connection 16 connected to the three volt power supply, unused connections 15, 13, 12, 11, 7 & 8. Micro-controller U1 has connection 10 connected through a resistor R6 (47 k) connected to ground and a connection 9 connected through capacitor C5 (2200 pF) to ground and through a resistor R5 (47 k) to the three volt power supply.

Connections 1 and 2 of micro-controller U1 are connected through resistors R9 and R10, respectively to LED 33 seen in FIG. 1, and thence to ground. Connection 3 is connected through a resistor R7 to connection 6, while connection 6 is connected to ground through a resistor R8 (27.4 k). Connection 4 of the micro-controller U1 is connected to the enable input EN of the DC-DC converter U2. Connection 7 of the micro-controller U1 may be utilized as a connect enablement feature for long term battery preservation. Although the battery 75 illustrated is situated such that the user can remove the battery, it has been found to be more desirable for certain models of the animal protector apparatus 21 to have batteries which are built-in, especially to enable the animal protector apparatus 21 to be miniaturized. When the battery is built-in, it may have a significant shelf life before it is used. If the electronics of the animal protector apparatus 21 are powered from the moment of manufacture, and if significant shelf time from inventory occurs, the battery may be depleted. Even if manufacturing to user time were reduced to zero, it is expected that the animal protector apparatus 21 will be utilized when an animal is injured and then stored away until the next use. To preserve the animal protector apparatus 21 having an internal battery 75 for a long period, pin 7 of micro-controller U1 is brought to a point seen in FIG. 7 labeled “I” adjacent the block #27 so that it can, possibly by mechanical grounding through another connector (not shown in FIG. 7) indicate to the micro-controller U1 to turn on. By keeping all of the electronics in the animal protector apparatus 21 shut down until an extended conductor set is connected, the power will only be used while the animal protector apparatus 21 circuitry is connected and ready for use on an injured animal.

### Microprocessor U1

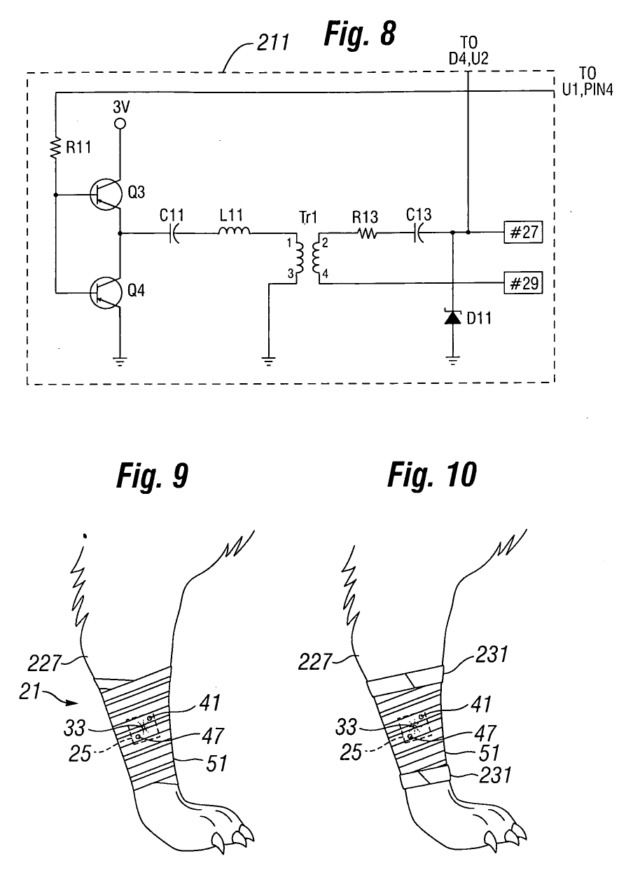

Referring to FIG. 8, the a DC-DC converter section 203 seen in FIG. 7 is replaced by an alternating current generation section 211. As an alternative to a sinusoidal AC signal, a switch could be placed at the output of U2 seen in FIG. 7 to give a switched alternating potential output. In the sinusoidal output circuit of FIG. 8, and as before, battery power is generated by the battery input and protection section 201, and is made available to a transistor Q3 (2N2222) with the output of transistor Q3 leading to an input of transistor Q4 (2N2907) and then to ground. The bases of the transistors Q3 and Q4 are joined and connected through a resistor R11 (100 ohms) and indicated as extending to the enablement line 4 of microprocessor U1.

The output of transistor Q3 and input of transistor Q4 is connected through a capacitor C11 (10 μF) and through an inductor L11 (1 μH) into a first input of a first side of a transformer TR1. The output of the first side of the transformer TR1 is connected to ground. An output side of transformer TR1 has a first terminal connected through a resistor R13 (10 k ohms) and a capacitor C13 and then to first terminal 27 and through a zener diode D11 to ground. Capacitor C13 permits a potential to be maintained between first and second terminals 27 and terminal 29 under non shock conditions, and yet passes the AC to terminal 27 under conditions of shock. The zener diode D11, and other diodes described herein, may be a Schottky diode. A second terminal of the output side of transformer TR1 is connected to second terminal 29. In the case of FIG. 8, rather than enabling a direct current source, the enable line 4 of microprocessor U1 enables the alternating current output circuitry of alternating current generation section 211, preferably by providing a pulse train signal. The circuit of FIG. 8, depending upon the values of C11, L11 and TR1 may have an output which may have a frequency of from about 200 to 400 Hz. Referring to FIG. 9, a view of the animal protector apparatus 21 attached over a bandage 225 dressing the leg 227 of an animal. As can be seen, the circuit board 25 underlies a section of the flexible circuit 51. The circuit board 25 is oriented so that the area 65 of transparent material enables viewing of an underlying light, such as an LED 33. The flexible circuit 51 is preferably applied in a spiral pattern in a way which causes the conductors 57 and 55 to have generally even adjacent spacing. In this pattern, the animal has an opportunity to make contact with two conductors 57 and 55 even if such contact is between such conductors along different lengths of the flexible circuit 51 due to the spiraling adjacency. Contact can be made between conductors 57 and 55 across same main expanse of plastic material 53 or between adjacent spirals of the main expanse of plastic material 53.

Referring to FIG. 10, a view of the animal protector apparatus 21 is seen as in FIG. 10, but with a band of securing adhesive tape 231 overlying the animal protector apparatus 21 at the top and bottom of the spiral. Such securing adhesive tape 231 may or may not cover the extreme ends of the spiral, and provide some additional resistance to molestation and the animal's ability to remove the flexible circuit 51.

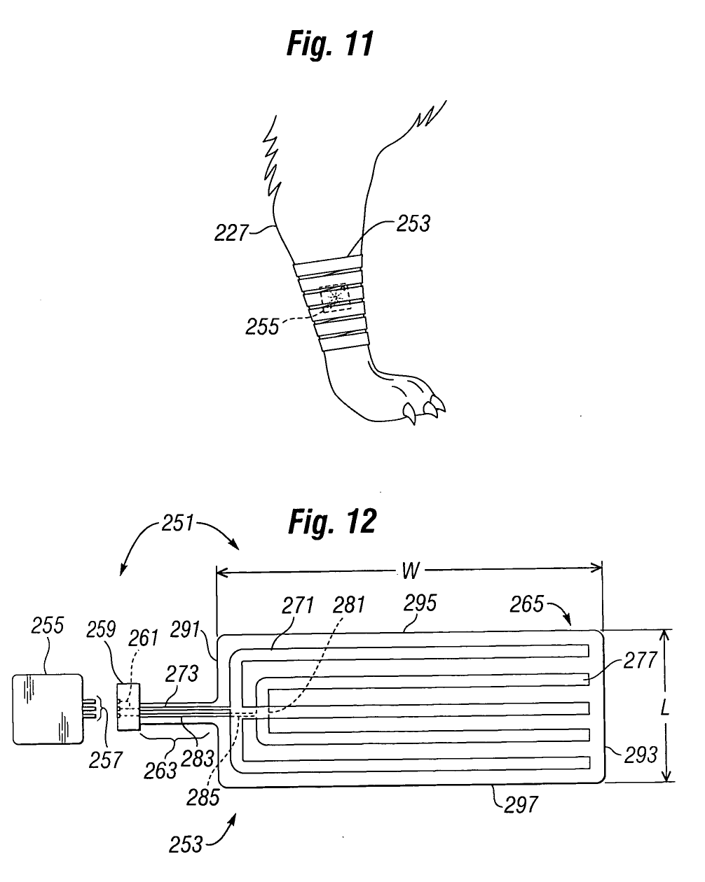

Referring to FIG. 11, an elevation view of an alternative embodiment illustrates a non-spiral laterally widened bandage protector 251 on a leg 227 of an animal. The bandage protector 251 has a number of conductive traces laterally duplicated along its width and can have an adhesive backing which can both provide adhesion to animal fur or skin as well as self adhesion in an overlapping configuration on top of any portions of the other end of the bandage protector 251 where it is long enough to form the overlap. Because the underlying adhesive surface is non-conductive, any overlap can still provide a continuous series of conductors surrounding the leg 227 of an animal. Further, the multiple adjacent conductors 55 and 57 need not exactly align and can overlap at an angle or laterally displaced. This represents a relaxation of both structural alignment and conductor alignment and enables good coverage over short lengths of injured legs 227 and accommodates a tapering profile in the animal's limb. The bandage protector 251 is seen to include a conductor circuit 253. Underneath the conductor circuit 253 which is outwardly disposed, a circuit board and power pack 255 is shown in dashed outline.

Referring to FIG. 12, an expanded view of the bandage protector 251 is seen in a flattened and unrolled view to better illustrate the dimensions thereof. Beginning at the left, the bandage protector 251 circuit board and power pack 255 is seen as being detached from the remainder of the bandage protector 251. The bandage protector 251 circuit board and power pack 255 is seen as having male connector 257, which is seen as having three prongs which correspond to the three connections seen in FIG. 7. Those three connections were connected to micro-controller U1 pins 9, 16 and 7. To the right of male connector 257, a female connector 259, which may be an insertion connector, is seen as having a short length of pigtail 263 and which is then physically structurally connected to a main expanse of flexible plastic material 265 upon which a number of conductors are positioned. Female connector 259 ideally has at least three input ports and a far side input port is seen as having a dashed line connection 261 which connects one of the input ports to the other. This function can be one of grounding (taking a connection such as pin seven of micro-controller U1 from a from a high potential to a low potential, or taking it from a low potential to a high potential. Other possibilities include the sending of pulses, or the testing of a signal from a sensing connector, such as pin 7 of micro-controller U1. Under any of these mechanisms, when the female connector 259 is connected to the male connector 257, the state of interconnect of the conductor circuit 253 to the circuit board and power pack 255 can be sensed by micro-controller U1, even if in a deep sleep mode, in order to power up to a needed level of readiness to begin functioning. As such, the circuit board and power pack 255 should remain disconnected from the bandage protector 251 when not in use, regardless of the connector system utilized. This will insure that the animal protector apparatus 21 has its battery 75 conserved when the apparatus is not being used to protect an animal.

It is understood that connector 257 could be a female connector and connector 259 could be male, but the ability to use the edge of the circuit board and power pack 255 may give a lower profile with connector 257 as male. The conductors include a first conductor set 271 formed as a series of three conductors paths which are arranged in an overall fork shape for shown with only three traces for simplicity pattern. A trace 273 can be seen as extending between the first conductor set 271 to the female connector 359 across the short length of pigtail 263.

A second conductor set 277 formed as a series of two conductor paths (shown as two for simplicity, it is expected that a working model may have many more than two) which are arranged in a “U“shaped pattern. A trace 283 can be seen as extending between the second conductor set 277 to the female connector 359 across the short length of pigtail 263, but a portion 285 of the trace 283 extends underneath a portion of the first conductor set 271. The face of the conductor sets 271 and 277 facing the observer of FIG. 12 are exposed, but where one portion of a conductor crosses any other conductor, it is insulated from that conductor. This is true for the portion 285 the trace 283, and also true for a portion 287 of the second conductor set 277 which extends underneath the first conductor set 271. The ability for conductor sets 271 and 277 to extend over and under each other without electrical contact enables a wide variety of specialized shapes and sizes of flexible plastic material 265, along with a corresponding multiple number of configurations of the conductor sets 271 and 277 to be made into patterns which may be advantageous in providing an array of conductors to best inhibit a pet from licking or chewing at or around the area to be protected. For all of the embodiments described hereinafter, the first and second conductor sets will be referred to with the numerals 271 and 277 even though they may take on a variety of duplicated branches and branch shapes.

The flexible plastic material 265 and its conductor sets 271 and 277 shown in FIG. 12 can be formed into a simple cylinder or frusto conic shape with one end overlapping over the other end. The flexible plastic material 265 has a pigtail or proximal end 291 and a distal end 293, and a pair of side ends 295 and 297. Because the flexible plastic material 265 is very thin and flexible, the ends 291, 293, 295 and 297 are actually very thin edges. In the embodiment shown, the ends 295 and 297 may be about ten inches long, while the proximal and distal ends 291 and 293 may be about three inches. The conductor sets 271 and 277 may have width, length, and numerosity. The selection of flexible plastic material 265 having a length of about ten inches will allow a sufficient overlap on most animals to hold the product on and foil an animal's attempts to remove the non-spiral laterally widened bandage protector 251. The side of the bandage protector 251 facing away from the observer in FIG. 12 will preferably include adhesive to enable the distal end 293 to extend around the leg 227 of the animal and continuing across the circuit board and power pack 255 and pigtail 263 and come to rest at some location overlapping the flexible plastic material 265 between the proximal and distal ends 291 and 293. Because the side of the flexible plastic material 265 opposite the observer of FIG. 12 is an insulator, any overlap with or without adhesive will not cause any shorting of the conductor sets 271 and 277.

The low profile of the circuit board and power pack 255 and pigtail 263 facilitates the ability of the non-spiral laterally widened bandage protector 251 to possibly overlap as it wraps around a leg 227 or other portion of an animal to form a more stable structure. The ability to apply tape to secure the distal end 293 is also enhanced, but in a manner which will not significantly block or restrict the presentation of the conductor sets 271 and 277 to an animal to which it is attached. Any mechanism or configuration which enables a flatter configuration will help defeat the ability of the animal to dislodge the bandage protector 251.

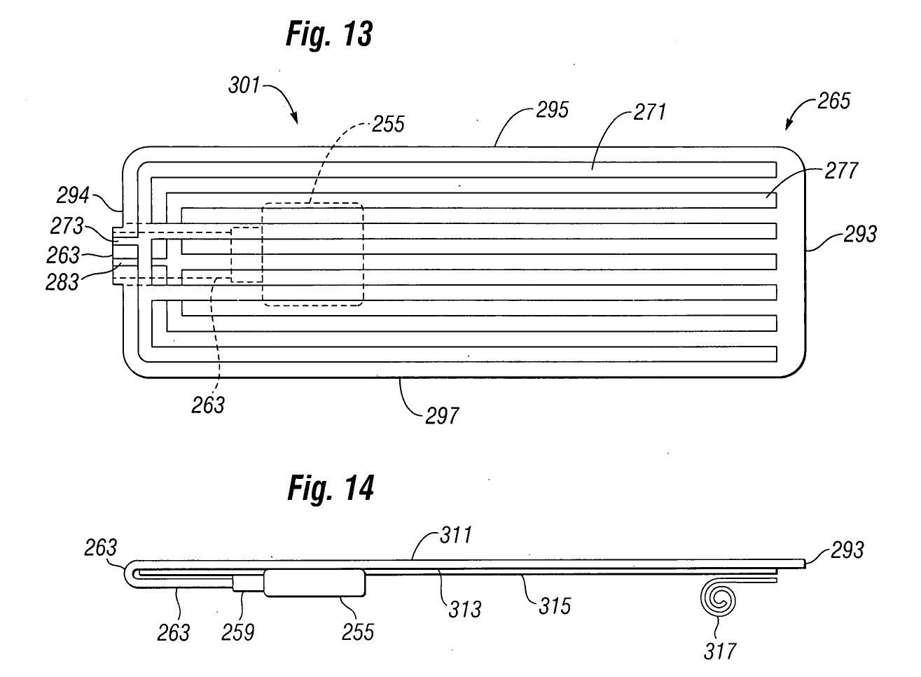

Referring to FIG. 13 a slightly different non-spiral laterally widened bandage protector 301 includes a slightly different main expanse of flexible plastic material 265 includes a different layout of conductor sets seen as a first conductor set 271 having four linear traces and a second, inner conductor set 277 having three linear traces which parallel and extend in between the first conductor set 271. The circuit board and power pack 255 is the same as in FIG. 12. Here, the first conductor set 271 extends laterally outside of the second conductor set 277 but this need not be the case. If one of the outside conductors of the first conductor set 271 were simply removed, an offset pattern would occur.

Also seen are the traces 273 and 283, as well as a portion of the pigtail 263 which is shown as having been folded around and behind the flexible plastic material 265. Since the rear of the flexible plastic material 265 contains an adhesive, the folding of the circuit board and power pack 255 will cause it to be supported and protected by the flexible plastic material 265. Where the length of the flexible plastic material 265 is long enough for a wrap around, the circuit board and power pack 255 may be covered by a portion of the flexible plastic material 265 as it encircles a limb. For example, but not limited to this particular application, the configuration shown in FIG. 13 could involve the application to the side or belly of an animal. Where the reverse side of the flexible plastic material 265 has a strong adhesive, the flexible plastic material 265 can provide its own holding strength. Any adhesive would also help hold the circuit board and power pack 255 against the rear of the flexible plastic material 265. Further, because the size and profile of the circuit board and power pack 255 is so small, it occupies only a small fraction, about eight percent for the dimensions previously described for the bandage protector 251 of FIG. 12. This insures that there will be sufficient additional area for adhesion. In the configuration shown, the flexible plastic material 265 protects the circuit board and power pack 255.

In addition to adhesive on the rear side of the flexible plastic material 265, a width of overlying tape can be applied along the edge of the flexible plastic material 265. In the alternative, a tape window with a cutout exposing the first and second conductor sets 271 and 277 could be used. In a further alternative, a narrow width of tape can be wrapped around the animal and which would cross a portion of the first and second conductor sets 271 and 277, but would help hold the bandage protectors 251 and 301 in place. Any partial covering of the first and second conductor sets 271 and 277 will not disable the protectors 21, 251 and 301, so long as the device covering them is not conductive. The potential for the existence of portions such as portion 285 and 287 which extend underneath other conductive structures will not be specifically identified.

Referring to FIG. 14, a view looking into the side end 297 gives a good illustration of the depth of the configuration seen with respect to FIG. 13. The protector 301 is seen as having a front side 311 which supports the first and second conductor sets 271 and 277, and a rear side 313 to which adhesive may likely be applied. Shown is an adhesive layer 315 and a release layer 317 which is used to cover the adhesive prior to installation of the protector 251 or 301. The adhesive layer may be provided in two or more forms, such as a latex adhesive which attaches well to self adhesive bandages such as may be used on an animal, while acrylic adhesive which might better adhere to skin tissue of an animal. The first and second conductor sets 271 and 277 may be preferably so thin that they are not practically observable from the view of FIG. 13.

The pigtail 263 is seen folded from its connection with the proximal end 291 of the main expanse of flexible plastic material 265 with which it may be integrally formed, and folded to extend along and opposite the rear side 313 of the main expanse of flexible plastic material 265. A gap is shown between the pigtail 263 which may be seen for illustration only as it is expected that any adhesive on the rear side 313 will cause the pigtail 263 to adhere to the rear side 313. Circuit board and power pack 255 is shown as adhered to or closely aligned against the rear side 313.

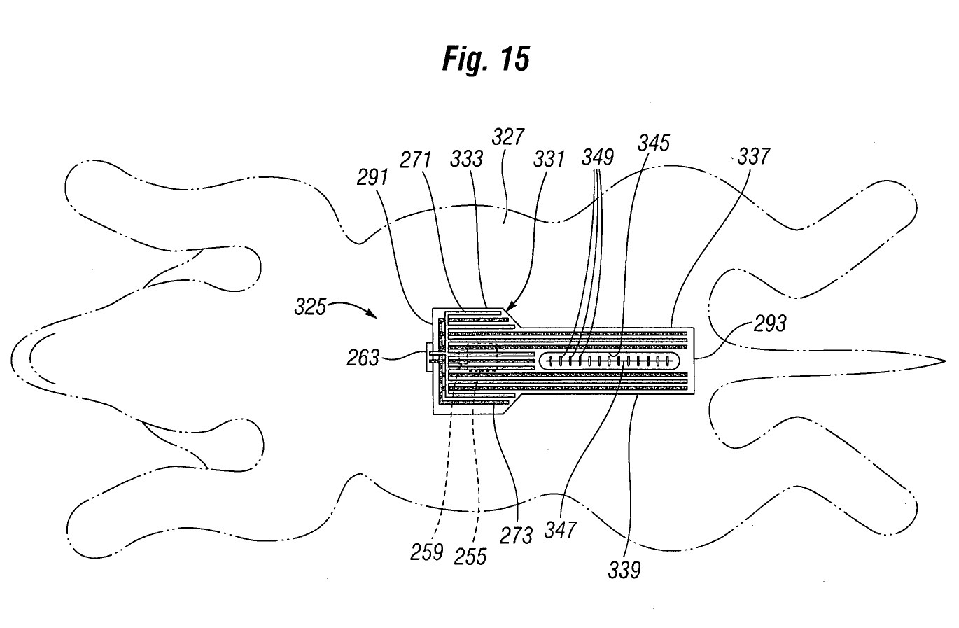

Referring to FIG. 15, a configuration similar to that seen in FIGS. 13 and 14 with the circuit board and power pack 255 seen in dashed line format folded to the rear, a spay patch configuration of a protector 325 is seen which may be advantageous for use with incisions, such as might be encountered with a spay or other operation. An animal's abdomen 327 is seen with the protector 325 including a main expanse of flexible plastic material 331 having a wide pair of side ends 333 and 335 adjacent the proximal end 291, and having a narrow pair of side ends 337 and 339 adjacent the distal end 293. Along a portion of the center length of the main expanse of flexible plastic material 331, an opening 345 enables an incision 347 having a set of stitches 349 to remain uncovered so that dry air can reach the incision 347. However, the main expanse of flexible plastic material 331 provides a number of alternating first and second conductor sets 271 and 277 as an expanded array to help dissuade the animal from reaching the healing incision 347. This is because an animal may turn to the left or right in order to attempt to reach the incision 347, and even though approaching from an angle will generally approach the main expanse of flexible plastic material 331 from a direction first reaching the proximal end 291 at its wide pair of side ends 333 and 335 edges 333 and 335, the increased width helps to protect the incision 347.

It may be preferable to either supply a number of different sizes of the main expanse of flexible plastic material 331 for different size dogs, as well as to supply a number of different width and lengths of openings 345 within a given overall size range of the main expanse of flexible plastic material 331 to enable veterinary practitioners to select an optimum size for each animal, the animals size and the size of the incision 347. Further, the opening 345 may have tear away perforations to enable the user to create the opening 345 and/or affect its length.

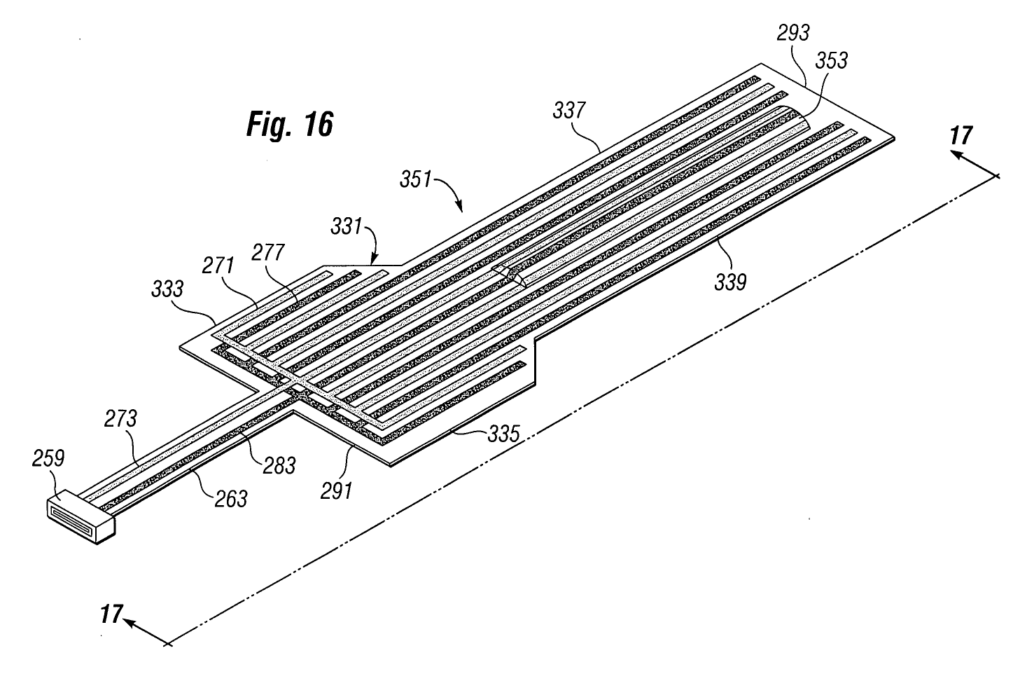

Referring to FIG. 16, an alternative configuration for a spay patch is shown and having many of the structures seen in FIG. 15. Circuit board and power pack 255 are omitted for simplicity. A spay patch configuration of a protector 351 is seen as having an elongated domed structure 353, which may have first and second conductor sets 271 and 277 extending over the top of the domed structure 353. At the distal end 293 of the main expanse of flexible plastic material 331 may be left open to allow some air to enter the space between the incision 273 and the bottom of the domed structure 353. The domed structure 353 is seen as a generally curved impression made in the bottom of the main expanse of flexible plastic material 331. Since the bottom inside of the domed structure 353 is expected to be high enough above the incision 347 and the stitches 349 that touching will not occur, no special care needs to be taken to keep the underside of the domed structure 353 from receiving adhesive. In the alternative, a portion of the release layer could be cut away from the portions of the release layer covering the non dome structure 353 portion of the rear side 313 of the protector 351. The other structures of protector 351 are the same or similar to those show in earlier Figures. The protector 351 is not shown in a folded position to emphasize that it is always possible to provide tape or other bandage to cover the circuit board and power pack 255. In some cases, a stronger bandage covering the circuit board and power pack 255 might cause the animal to preferentially ignore the incision 347. In the case of a spay patch, where the circuit board and power pack 255, and connector 259 can be secured in a position not underneath the main expanse of flexible plastic material 331, where possible or desirable.

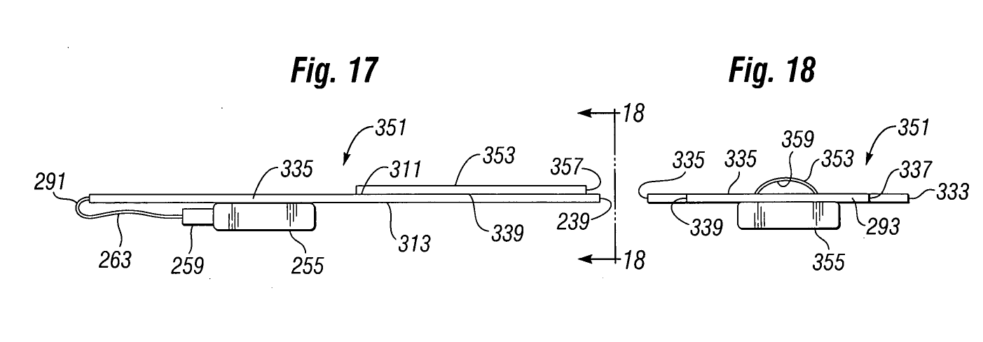

Referring to FIG. 17, a side view looking into the protector 351 along line 17-17 of FIG. 16 illustrates a domed structure 353 having an end 357 which terminates just before the distal end 293 and which may be closed or open. The adhesive layer 315 and release layer 317 are not shown, for simplicity. Referring to FIG. 18, an end view looking into the protector 351 along line 18-18 of FIG. 17 illustrates that the end 357 of the domed structure 353 is open. An inside surface 359 of the domed structure 353 is shown as providing a significant clearance above the rear side 313 which would adhere to the skin of the animal around the incision 347.

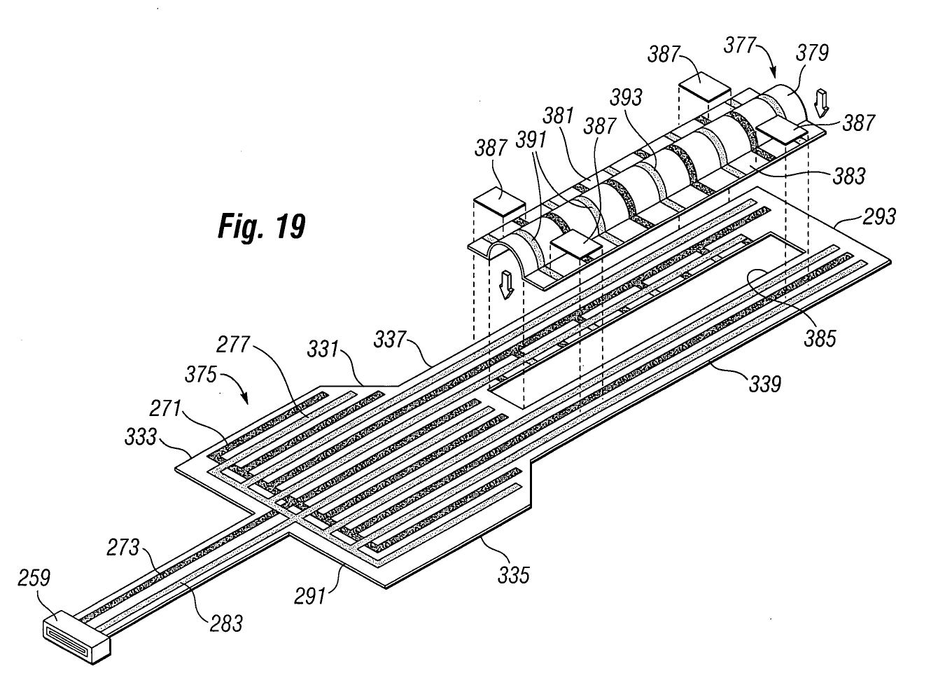

Referring to FIG. 19, an alternative configuration for a spay patch is shown having a multi-piece structure replacing the elongate domed structure 353. Circuit board and power pack 255 are omitted for simplicity. A spay patch configuration of a protector 375 has a separate domed structure 377 having a curved dome 379 and a pair of parallel flanges including first flange 381 and a second flange 383. The flanges 381 and 383 can be used for attachment to the front side 311 of the main expanse of flexible plastic material 331, or the flanges 381 and 383 can prevent upward disconnection of the separate domed structure 377 by being slipped underneath a central aperture 385. The separate domed structure 377 can be electrically connected to the first and second conductor sets 271 and 277 using a series of conductive foil layers 387 which will electrically connect the first and second conductor sets 271 and 277 onto a separate conductor set or sets located on the separate domed structure 377. The configuration and location of the series of conductive foil layers 387 will depend upon the location of the next most adjacent ones of the first and second conductor sets 271 and 277 available, as well as any conductor sets 391 and 393 on the separate domed structure 377. This will allow either the production of a spay patch configuration with a standard aperture 385 and the optional use of one or a number of separate domed structures such that the user can configure the protector 375 for their particular use.

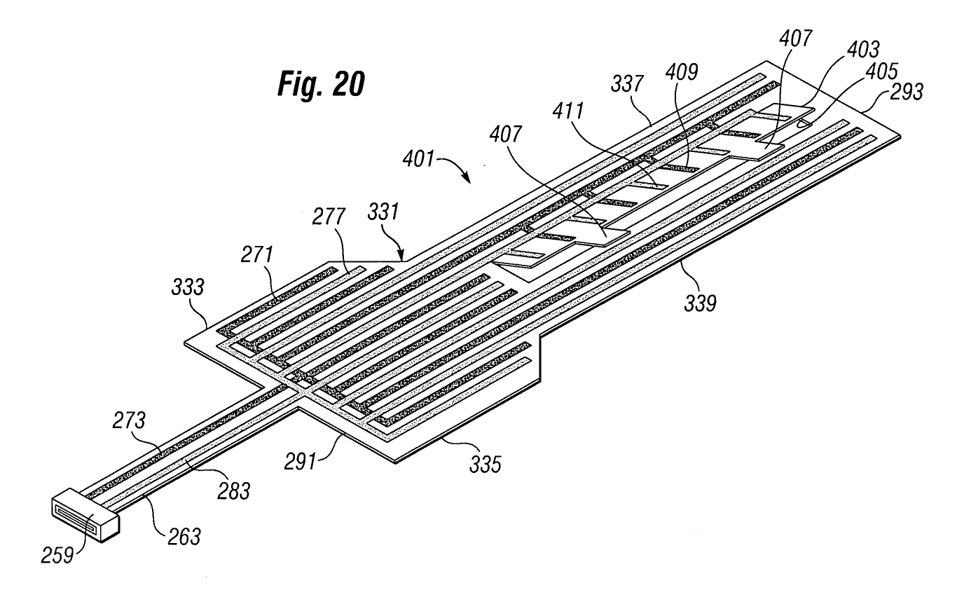

Referring to FIG. 20, a further alternative configuration for a spay patch is shown having a flap which can be used with or without a dome-type structures, and is seen as a protector 401 having flap 403 which is illustrated as lifted slightly to expose an aperture 405. Circuit board and power pack 255 are omitted for simplicity. A set of abbreviated length hold-down tabs 407. Further, the separate domed structure 377 see in FIG. 19 could be slipped underneath the main expanse of flexible plastic material 331 of the protector 401 to cause the flap to raise and assume the shape of the separate domed structure 377 to the extent possible. As can be seen, a series of angled conductors 409 and 411 extend in a direction generally laterally across the flap 403 throughout its length. The hold-down tabs 407 could be used to secure the free edge of the flap 403 down onto the separate domed structure 377 in a manner which enables the flap 403 to partially assume the shape of the separate domed structure 377.

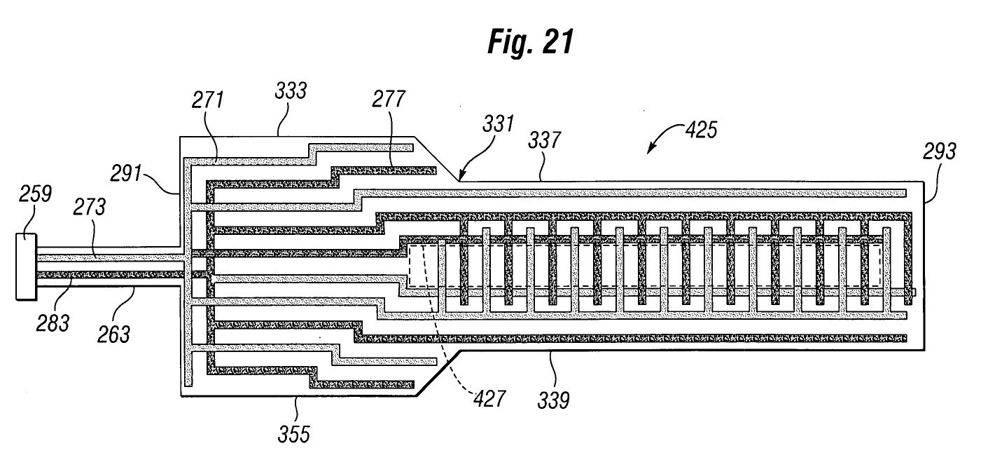

Referring to FIG. 21, a protector 425 includes a relatively more dense set of alternating conductors. Circuit board and power pack 255 are omitted for simplicity. The high density of the alternating conductors associated with the first and second conductor set 271 and 277 are at the center of the protector 425 and closer to the distal end 293. A dashed line perforation 427 is rectangle shaped and enables removal of a pre-perforated section of the main expanse of flexible plastic material 331 containing the higher density set of conductors of the first and second conductor set 271 and 277. This enables the section within the perforation 427 to be removed to form an aperture such as apertures 385 or 345. The removal of the section will not short out any of the conductors either bordering or crossing the perforation 427. If the section within the perforation 427 is left in tact, the protector 425 will function normally. Further, the high density overlap seen in FIG. 21, and adjacent and within the perforation 427 can also be used in conjunction with any main expanse of flexible plastic material 331 where the conductor spacing creating the shock needs to be more closely spaced.

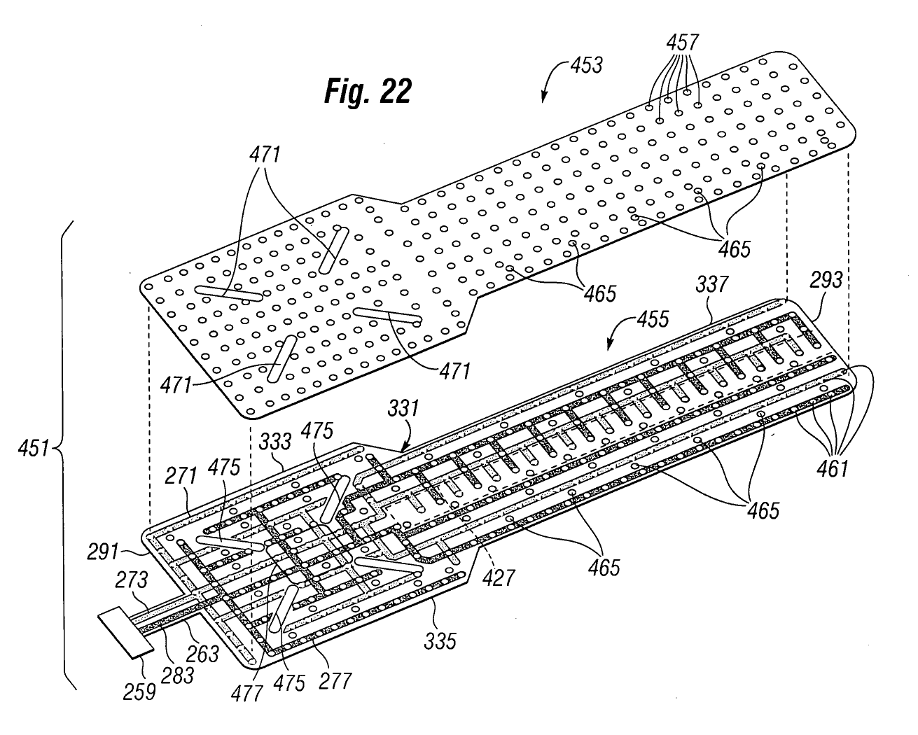

Referring to FIG. 22, an exploded perspective view of a protector 451 which includes an over layer 453 having apertures 457 and which may be affixed over a main expanse of flexible plastic material 455, or it may be applied as a layer of insulative ink onto the main expanse of flexible plastic material 455 to further restrict the exposed surface area of the first conductor set 271 and the second conductor set 277. The over layer 453 may be very thin or it may be significantly thick enough to remove any laterally extending conductive structure from contact with the exposed portions of the first conductor set 271 and the second conductor set 277. The apertures may have an effective diameter (if circular, though the apertures 457 can be of any shape) in relationship to its thickness so as to prevent non-body parts of the animal from making effective contact with the first and second conductor sets 271 and 277. Larger apertures 457 and may dictate a thicker over layer 453 to achieve this inadvertent shorting inhibition. In an extreme case, the over layer 453 may be laid down in an insulative pattern with smaller effective apertures, similar to the manner in which newsprint is laid down, in order to limit the ability for an animal to achieve contact between the first and second conductor sets 271 and 277 in a manner other than would occur were the animal licking or attempting to chew a protector 451.

The main expanse of flexible plastic material 455 has similar features as those earlier shown including proximal and distal ends 291 and 293, side ends 295 and 297 and wide pair of side ends 333 and 335. However, where the total flexibility of the material supporting the first and second conductor sets 271 and 277 is sought to be pre-specified, the thickness and flexibility of the over layer 453 in combination with the thickness and flexibility of the main expanse of flexible plastic material 455 should be considered.

Over layer 453 may be a clear flexible vinyl layer with a series of apertures 457 which provide a more limited touch access through to the main expanse of flexible plastic material 455. Each of the apertures 457 are sized and, along with the thickness of the over layer 453 provide a natural amount of recess such that they enable and facilitate an animal tongue, possibly with its saliva making electrical contact with traces on the a main expanse of flexible plastic material 455, but insulating the traces from momentary animal contact with the conductive bars of a cage and other flat contact with the protector 451 against a conductive surface, such as a conductive metal wall or cage. The over layer 453 may not be as desirable in situations where the animal to be protected is not expected to make direct contact with metal bars.

The apertures 457 are shown as round and preferably align with positions over the first and second conductor sets 271 and 277. It should be emphasized that the first and second conductor sets 271 and 277 have been shown throughout this application at a width which facilitates illustration, but that they can be wider and can come very close to each other. It must also be emphasized that the apertures 457 follow and overlie the first and second conductor sets 271 and 277 to insure that electrical conductivity will be between adjacent apertures 457 rather than produce a current flow through animal saliva within a same aperture 457. To achieve this, each of the apertures 457 is placed as directly over an associated one first and second conductor sets 271 and 277 as is possible. Advanced manufacturing techniques enable such alignment. A series of dashed circles 461 appear on the first and second conductor sets 271 and 277 which indicates area segments which will underlie the apertures 457.

Note that circles 461 appear along the first and second conductor sets 271 and 277 and are shown generally, for purposes of efficiency, to have a diameter of about the same width as the first and second conductor sets 271 and 277. The first and second conductor sets 271 and 277 can be wider, the apertures 457 can be larger, and the circles 461 (the negative footprint of the apertures 457) can be larger, smaller, or of different shape. As can be seen, the circles 461 which appear along the first and second conductor sets 271 and 277, are spaced such that about two additional circles 461 apertures could fall along the first and second conductor sets 271 and 277. The circles 461 could be sized to go beyond the boundaries of the first and second conductor sets 271 and 277.

It may be desirable to configure the apertures 457 in a regular pattern to match the first and second conductor sets 271 and 277. The ability for alignment is dependent upon the accuracy of manufacturing. As can be seen, the overall location of the first and second conductor sets 271 and 277 follows a structured pattern such that the apertures 457 (apertures through which tongue tissue and saliva conduction may occur) may be regularly arranged. An optional second set of through structures are seen as solid circular structures and are located not on the first and second conductor sets 271 and 277. These are seen as wound breathing apertures 465. The apertures 465 will allow moisture in the wound or in the tissue adjacent the wound to leave by evaporation. Only a few of the wound breathing apertures 465 are shown, for simplicity, as showing more distributed adjacent all of the apertures 457 might obscure the view of FIG. 22.

In practice, it may be preferable to punch apertures 457 in the over layer 453 before applying it over the main expanse of flexible plastic material 331. The over layer 453 may have an adhesive underlayer (not seen) applied before or after the apertures 467 are punched. Any other means can be used to affix the over layer 453 to the main expanse of flexible plastic material 331. As an example, attachment may be had along the proximal and distal ends 291 and 293, side ends 295 and 297 and wide pair of side ends 333 and 335 to form an envelope. Then, after the over layer 453 is applied onto the main expanse of flexible plastic material 331, the through apertures 465 (shown in both the over layer 453 and main expanse of flexible plastic material 331) may then be formed with due consideration to make a pattern which preferably does not pass through or nick any portion of the first and second conductor sets 271 and 277.

Where a main expanse of flexible plastic material 455 similar to that used in the earlier figures includes a dashed line perforation 427, it will not likely be used for the protector 451. The protector 451 might be packaged to include the over layer 453 which can be peeled off to enable use of the main expanse of flexible plastic material 455 as a stand alone structure and which might include earlier configurations such as removal of a middle area about the perforations 427, with apertures 465 and apertures 467 on the over layer 453 on the over layer 453 arranged in a pre-specified pattern to overlie apertures 465 and first and second conductor sets 271 and 277 properly.

Also seen in the over layer 453 a set of four slots 471 which are linearly directed with respect to a proposed center location about which the circuit board and power pack 255 may rest when flipped behind the main expanse of flexible plastic material 455. Normally, where the main expanse of flexible plastic material 455 and over layer 453 is relatively stiff, the area surrounding the circuit board and power pack 255 at the rear of the protector 451 might have a tendency to “tent”. This tenting effect would mean that a portion of the area of the adhesive layer 315 immediately around the circuit board and power pack 255 might tend to be lifted by the circuit board and power pack 255 and otherwise prevent adhesion to the skin of the animal, such as abdomen 327 to which it would otherwise be attached. A corresponding set of slots 475 are formed in the main expanse of flexible plastic material 455 and align with slots 471. The circuit board and power pack 255 is expected to occupy a target area 477.

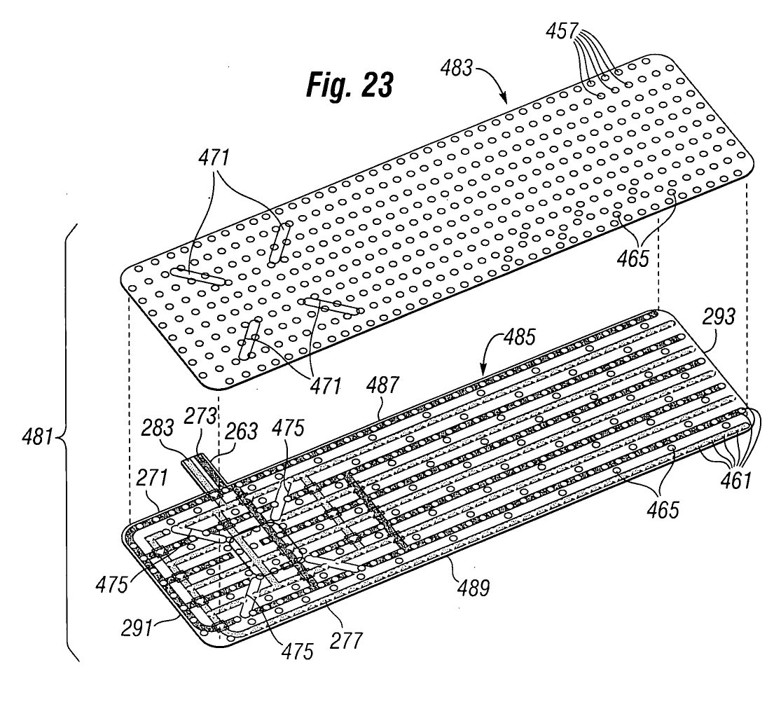

Referring to FIG. 23, an exploded perspective view of a protector 481 which includes an over layer 483 which may be affixed over a main expanse of flexible plastic material 485. Protector 481 is rectangularly shaped and has a short length of pigtail 263 which extends not from a proximal end, but from a side 487 which is a main side of the rectangular shape, although it could extend from any location. Opposite main side 487 is a main side 489. The over layer 483 of the protector 481 has a more even pattern of apertures 457. In fact, the apertures are so regular that the slots 471 tend to interrupt portions of the apertures 457. The same is true of the slots 475 which interrupt the first and second conductor sets 271 and 277. Thus, protector 481 also illustrates a much more dense set of apertures 457 which provide less interspacing.

In both the protectors 451 and 481 of FIGS. 22 and 23, the fact that slots 471 and 474 will interrupt portions of the first and second conductor sets 271 and 277 have led to some duplicating interconnection of the first and second conductor sets 271 and 277 so that the cutting or punching of slots 475 and any potential punched out areas around perforations 427 will not result in a disabling open circuit of other portions of the protectors 451 and 481. It is expected that even further duplicating interconnection might be employed especially if it were desired to increased the density of contact areas which were located underneath the over layer 483. Further, even though the over layer 483 has been shown as a separate layer which might have optional breathing apertures 465, only a few of these are identified to avoid overcrowding the figure, as was done in FIG. 22.

Generally, it is understood that the same non-conductive ink technology which enables the first and second conductor sets 271 and 277 to be extended underneath and over each other could be employed to create small rounded areas of exposure of the first and second conductor sets 271 and 277 along their lengths and which would operate the same way as an over layer 483 (or over layer 453), and leaving the apertures 457 or wound breathing apertures 465 or a combination of both. The insulative ink layer can be thick enough to encounter any planar or linear conductive material which might be expected to be encountered.

Chemical agents can be used in conjunction with any or all of the protectors 251 301 325, 351 375, 401, 425, 451 and 481.

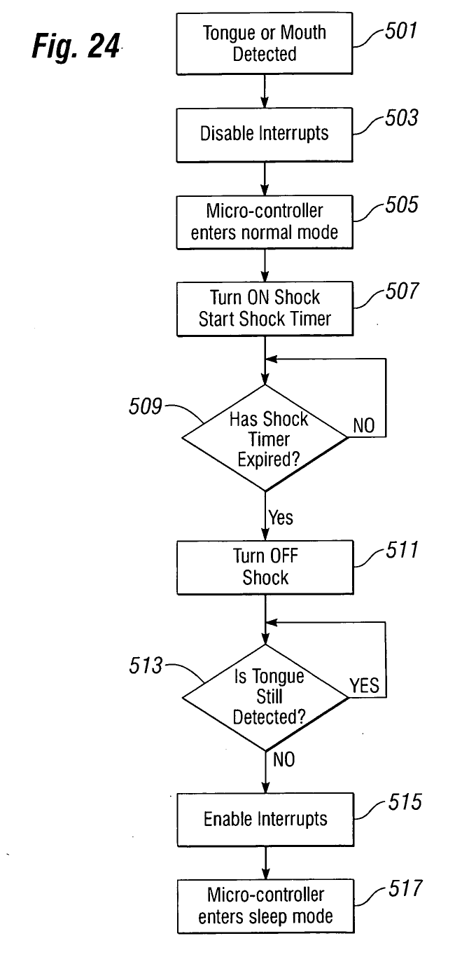

Referring to FIG. 24 a simplified process flow diagram illustrates another one possible realization of an interrupt routine which may be used in place of the routine seen in FIG. 6. As in the case of the interrupt routine of FIG. 6, the logic can flow into single linear routine of FIG. 24 occur from any point in the normal cyclic functioning seen in the block diagram of FIG. 5, below the “enable interrupts” block 105. As before, interrupt is triggered by the detection of disturbances in any of the terminals of any of the embodiments illustrated in the invention. The logic described in FIG. 24 in essence allows a shock after a tongue is detected, but after an open circuit. Put another way, if a large conductive drool across any opposite polarity terminals, a shock will be applied, but a further shock will not be applied until an open circuit is detected first. This will prevent any power drainage where a tongue continues to be detected, rather than continually administering a shock, even though with ever increasing times between the shocks, as was illustrated with respect to FIG. 6.

At the uppermost portion of FIG. 24, the logic can arrive at a “Tongue or Mouth Detected” block 501 by interrupt or other technique from the logic flow of FIG. 5. From the “Tongue or Mouth Detected” block 501, the logic flows to a “Disable Interrupts” block 503 where further interrupts will be disabled so that the steps in the remainder of FIG. 24 be executed exclusively. The logic then flows to a “Micro-controller enters normal mode” block 505 where it is made sure that the micro-controller 83 will be brought out of low power mode (should it have been in low power mode at the time the logic flow in FIG. 24 began) and enabled for full function.

Next, the logic flows to a “TURN ON Shock Start Shock Timer” block 507 where the shock is turned on while a countdown or termination time is started. The shock will continue for the duration of the time set by a shock timer, and this time may be varied for use with larger or smaller animals. The logic then flows to a “Has Shock Timer Expired?” decision diamond 509. Where the shock timer is not expired, a NO result allows the shock continues in the on position and the logic continually flows back to the “Has Shock Timer Expired?” decision diamond 509. Once the shock timer has expired, a “YES” result allows the logic to flow to a “Is Tongue Still Detected?” decision diamond 511. A “YES” result occurs when the full duration of the shock has been applied and allows the logic to flow to a “Turn Off Shock” block 511 which shuts off the application of shock.

Generally, it is expected that a condition other than an open circuit over the first and second conductor sets 271 and 277 might occur for a number of reasons. An animal may have left a large dollop of conductive slobber or mucus across two of the opposite polarity traces. The animal may have pressed the protectors 251 301 325, 351, 375, 401, 425, 451 or 481 against a conductive surface for an extended period of time. An Animal might have bitten one of the protectors 251 301 325, 351, 375, 401, 425, 451 or 481 to cause it to short out. For any of these reasons, a “YES” result from the “Is Tongue Still Detected?” decision diamond 513 directs the logic flow continually back to the “Is Tongue Still Detected?” decision diamond 513. As a result, any extended time connectivity will result in the logic flow continually flowing into and out of the “Is Tongue Still Detected?” decision diamond 513. The only power drain will occur due to the micro-controller 83 continuing in normal mode rather than sleep mode.

If an open circuit is detected at the first and second conductor sets 271 and 277, a “NO” result will occur at the “Is Tongue Still Detected?” decision diamond 513, to then allow the logic to flow to an “Enable Interrupts” block 515. From the viewpoint of the logic flow seen on FIG. 24, the re-enablement of the interrupts at block 515 enables the logic to again be brought to the logic flow seen on FIG. 24. The logic then flows to a “Micro-controller enters sleep mode” block 517 which corresponds to a logic flow equivalent to a return step, typically downstream of the “micro-controller enters low power mode” block 115 seen in FIG. 5.

The logic produced by the logic flow of FIG. 24, in essence returns the control to the logic flow of FIG. 5 each time that a closed circuit or tongue detection is detected after a shock. This requires that a second shock occur only through the mechanism of tongue detection as an interrupt with respect to the logic of FIG. 5. The technique of FIG. 24 has a number of advantages. First, by guiding the logic flow back to the normal processing mode of FIG. 5, it causes any of the steps and components of normal operation to be re-accessed. It also causes re-triggering of an interrupt upon further tongue detection and a return of the logic back to the logic flow of FIG. 24. It is emphasized that the logic approach of FIG. 24 and FIG. 6 are alternative subroutines which might be pre-specified in a single one of protectors 251 301 325, 351, 375, 401, 425, 451 or 481 at the time of programming.

While the present invention has been described in terms of a smart animal wound area protector for long lasting and repeated usage which intelligently monitors and limits the amount of dissuasive shock delivered to an animal to modify its behavior, and to a powered circuit with a detachable, replaceable adhesive attachable flexible extended circuit, one skilled in the art will realize that the structure and techniques of the present invention can be applied to many clothing appliances and especially appliances which utilize the embodiments of the invention or any process which utilizes the apparatus and steps of the invention.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed is:

1. A wound disturbance protection device comprising:
a circuit assembly comprising:
a sensible voltage output circuit having an output;
a micro-controller controllably connected to the direct current-direct current circuit for triggering the output of the sensible voltage output circuit;
a potential detection circuit connected to the output of the sensible voltage output circuit and to an input of the micro-controller;
a battery connected to power the sensible voltage output circuit, the micro-controller and the potential detection circuit; and
a flexible extended circuit detachably connected to the output of the sensible voltage output circuit, so that the flexible extended circuit can be replaced.

2. The wound disturbance protection device as recited in claim 1 wherein the sensible voltage output circuit outputs a direct current voltage.

3. The wound disturbance protection device as recited in claim 2 wherein the sensible voltage output circuit outputs a voltage higher than the voltage of the battery.

4. The wound disturbance protection device as recited in claim 1 wherein the sensible voltage output circuit outputs an alternating voltage.

5. The wound disturbance protection device as recited in claim 1 wherein the battery has a nominal voltage of about three volts and the sensible voltage output circuit outputs a voltage of at least twenty-five volts.

6. The wound disturbance protection device as recited in claim 1 and wherein the flexible extended circuit further comprises:
an area of non-conductive material having a first side and a second side;
a plurality of interconnected first conductors attached to the first side of the non-conductive material;
a plurality of interconnected second conductors attached to the first side of the non-conductive material and not in contact with said plurality of interconnected first conductors.

7. The wound disturbance protection device as recited in claim 6 wherein the plurality of interconnected first conductors overlap with respect to the plurality of interconnected second conductors without making electrical contact with the plurality of interconnected second conductors.

8. The wound disturbance protection device as recited in claim 6 and wherein the micro-controller is configured to trigger the output of the direct current-direct current circuit upon detecting the presence of a drop in the potential between the first and second conductors from contact of a third object and the first and second conductors.

9. The wound disturbance protection device as recited in claim 8 and wherein the micro-controller is configured to trigger the output of the direct current-direct current circuit upon detecting the presence of a drop in the potential between the first and second conductors from contact of a third object and the first and second conductors only after detecting a restored potential between the first and second conductors.

10. The wound disturbance protection device as recited in claim 6 and further comprising an over layer limiting an effective exposed surface of the first and second conductors to help prevent a connection between the first and second conductors other than from the mouth of an animal.

11. The wound disturbance protection device as recited in claim 10 wherein the over layer has a plurality of apertures for permitting limited exposure of the first and second conductors.

12. The wound disturbance protection device as recited in claim 1 wherein the flexible extended circuit detachably connected to the output of the sensible voltage output circuit utilizes an insertion connector.

13. A wound disturbance protection device comprising:
a flexible extended circuit having an area of non-conductive material having a first side and a second side;
a first conductor attached to the first side of the non-conductive material;
a second conductor attached to the first side of the non-conductive material and spaced apart from the first conductor;
a layer of adhesive attached to the second side of the non-conductive material; and
a controlled sensible voltage output circuit, detachably connected to the first and second conductors with a flexible pigtail to enable the controlled sensible voltage output circuit to be folded behind the flexible extended circuit to protect and support the controlled sensible voltage output circuit, the controlled sensible voltage output circuit for applying a time limited voltage potential between the first and second conductors upon detecting contact between the first and second conductors by a structural portion of an animal.

14. The wound disturbance protection device recited in claim 13 wherein the flexible extended circuit has a first end and a second end and wherein the controlled sensible voltage output circuit is attached to the flexible extended circuit spaced apart from the first and second ends of the flexible extended circuit.

15. The wound disturbance protection device recited in claim 13 wherein the flexible extended circuit has at least one slot to facilitate the controlled sensible voltage output circuit to be supported behind the flexible extended circuit.

16. The wound disturbance protection device recited in claim 13 wherein the micro-controller can sense a connection of the flexible extended circuit to the output of the sensible voltage output circuit, so that the micro-controller can assume a battery conserving deep sleep state when the flexible extended circuit is detached from the output of the sensible voltage output circuit.
